(19) United States
(12) Patent Application Publication
(10) Pub. No.: US 2004/0115540 A1
(43) Pub. Date: Jun. 17, 2004

(54) Color cathode ray tube, method of manufacture thereof and method of creating fluorescent screen

(76) Inventor: Koji Saita, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/650,656

(22) Filed: Aug. 28, 2003

(30) Foreign Application Priority Data
Sep. 3, 2002 (JP) P2002-258008

(51) Int. Cl. H01J 9/00

(52) U.S. Cl. 430/24; 313/461

(57) ABSTRACT

A color cathode ray tube having a black matrix fluorescent screen of a high degree of accuracy and in which the accuracy of beam transmissive aperture edges of a color selecting mechanism is moderated, as well as a method of manufacture thereof are provided. On the color selecting mechanism, a resist pattern that is independent of the pattern of beam transmissive apertures of the color selecting mechanism is formed, and a fluorescent screen is created using the resist pattern as a mask. After creating the fluorescent screen, resist patterns are removed to form the color selecting mechanism. The color cathode ray tube is configured by positioning this color mechanism in such a way that it faces the color fluorescent screen created in the manner described above.

### CROSS REFERENCE TO RELATED APPLICATIONS

The present document claims priority to Japanese Priority Document JP2002-258008, filed in the Japanese Patent Office on Sep. 3, 2002, the entire contents of which are incorporated herein by reference to the extent permitted by law.

### BACKGROUND OF THE INVENTION

1. Field of the Invention

The present invention relates to a color cathode ray tube, a method of manufacture thereof, and a method of making a fluorescent screen.

2. Description of the Related Art

In general, a color cathode ray tube includes, as shown in FIG. 1, a so-called black matrix color fluorescent screen 3 having, on the inner surface of a panel 2 of the tube housing, a red phosphor layer 4R, a green phosphor layer 4G, a blue phosphor layer 4B and carbon layers 5 serving as light absorbing layers between each of the phosphor layers. A color cathode ray tube also includes a color selecting mechanism 6 positioned opposite the color fluorescent screen 3. Electron beams corresponding to the respective colors and which are emitted from an electron gun (or electron guns) are irradiated on each of the phosphor layers 4 [4R, 4G, 4B] after passing through beam transmissive apertures 7 in the color selecting mechanism 6. The beam width W₁ of each beam is wider than the width W₂ of the phosphor layers 4 of each color, and each beam is irradiated so as to cover some area of the respective carbon layers 5 as well.

FIG. 2 shows a color selecting mechanism 6 called an aperture grill. This color selecting mechanism 6 is provided with a metal frame 15 including a pair of opposing support members 11 and 12, and elasticity creating members 13 and 14 extending between these support members 11 and 12. In addition, a mask member having numerous beam transmissive apertures 16 in the form of slits along a single direction between the opposing support members 11 and 12 of the frame 15, for example the horizontal direction of the screen, in other words, a color selecting electrode thin plate 18, is provided. The color selecting electrode thin plate 18 includes a metal thin plate, and is configured such that numerous elongate grid element assemblies 17 are arrayed in the single direction mentioned above, and the slit-shaped beam transmissive apertures 16 are formed between neighboring element assemblies 17. The slit-shaped beam transmissive apertures are formed through etching.

The color fluorescent screen 3 mentioned above is created using the color selecting mechanism 6 as a mask. In other words, making use of the spreading of light due to diffraction, stripes of phosphor layers having widths that are narrower than the width of the beam transmissive apertures (the slit width) are formed. For example, assuming an applied phosphor film has a required thickness, when an exposure light, whose light intensity distribution has a Gaussian distribution, is irradiated on this applied phosphor film, exposure corresponding to that Gaussian distribution is done. Since a method of processing by blowing water thereon and etching mechanically is adopted, by controlling the water pressure during this time, stripes of phosphor layers having widths that are narrower than the width of the beam transmissive apertures are formed.

However, because the slit edges of the beam transmissive apertures 16 also serve as a mask for controlling the width of electron beams and for exposure of the fluorescent screen, an extremely high accuracy is demanded. In other words, as a mask for exposure, because errors are magnified, high accuracy is necessary. However, for the purpose of controlling the width of electron beams, such high accuracy is unnecessary. This is because electron beams are irradiated in such a manner as to run onto the carbon layers on both sides of a phosphor layer, even if the stripe edges of the beam transmissive apertures 16 are not sharp, it is not a problem because the carbon layers hide them.

In addition, because the color selecting electrode thin plate 18 is provided with a plurality of elongate grid elements 17, its strength suffers as it becomes larger and more fine pitched, and it becomes more likely that variances in pitch will occur. For this reason, the thickness of the color selecting electrode thin plate 18 has to be increased for purposes of handling.

On the other hand, because the beam transmissive apertures 16 of the color selecting mechanism 6 are formed through etching, there is a limit to the accuracy of the slit edges, and thus there is a limit to the sharpness of the strip edges of the phosphor layers that can be obtained through exposure and processing using this color selecting mechanism 6 as a mask. In addition, because phosphor stripe layers having a thickness that is narrower than the width of the beam transmissive apertures are formed utilizing the spreading of light through due to diffraction, it is difficult to control the stripe width with great accuracy.

### SUMMARY OF THE INVENTION

The present invention, in view of the aspects mentioned above, provides a color cathode ray tube that moderates the accuracy of beam transmissive aperture edges of a color selecting mechanism, while having a black matrix color fluorescent screen of a higher accuracy, as well as a method of manufacture thereof.

Specifically, the present invention seeks to provide a cathode ray tube that is made applicable to post focusing types having a color selecting mechanism with high beam transmissivity, as well as a method of manufacture thereof.

The present invention provides a method of making fluorescent screens, which makes it possible to obtain black matrix color fluorescent screens of a higher accuracy, or fluorescent screens for post focusing color cathode ray tubes.

A color cathode ray tube related to the present invention may be equipped with a color selecting mechanism in which a resist pattern independent of beam transmissive apertures of the color selecting mechanism is formed, which has a color fluorescent screen made using this resist pattern as a mask, and in which the resist pattern is removed.

According to a color cathode ray tube of an embodiment of the present invention, because it has a color fluorescent screen created through exposure and processing using a resist pattern on a color selecting mechanism that is independent of beam transmissive apertures of the color selecting mechanism, the edges of the phosphor layers become sharper, the fluorescent screen becomes more accurate, and images of a higher quality can be obtained. In addition, because the resist pattern of the color selecting mechanism is removed, the accuracy of the beam transmissive apertures of the color selecting mechanism is moderated. By having such a color selecting mechanism, high positioning accuracy of the phosphor layers and the beam transmissive apertures of the color selecting mechanism can be achieved, and at the same time, the ratio of the width or diameter of the beam transmissive apertures of the color selecting mechanism to the width or diameter of the phosphor layers can be set arbitrarily. As a result, a black matrix cathode ray tube or a post focusing cathode ray tube can be made more accurate.

A method of manufacturing a color cathode ray tube related to an embodiment of the present invention includes the steps of forming, on a color selecting mechanism, a resist pattern that is independent of beam transmissive apertures of the color selecting mechanism, creating a fluorescent screen using the resist pattern as a mask, and removing the resist pattern after creating the fluorescent screen.

According to the method described above, because the transmissivity of the resist pattern serving as a mask for creating the fluorescent screen and the transmissivity of the color selecting mechanism can be set independent of each other, it is made possible to obtain more stable exposure conditions for the phosphor layers. In addition, since the resist pattern is formed through an exposure and processing procedure, the accuracy of the pattern edges thereof is higher as compared to a case where it is formed through etching. By creating the fluorescent screen using this resist pattern, it becomes possible to obtain a fluorescent screen of a higher accuracy. On the other hand, because the resist pattern is removed from the color selecting mechanism, the beam transmissive aperture edges of the color selecting mechanism become unnecessary for exposure at the time of creating the fluorescent screen, and the accuracy requirement is largely moderated.

A method of making a fluorescent screen related to an embodiment of the present invention includes the steps of forming on a color selecting mechanism a resist pattern that is independent of beam transmissive apertures of the color selecting mechanism, and performing exposure for creating the fluorescent screen using the resist pattern as a mask.

According to the method described above, because the transmissivity of the color selecting mechanism and the transmissivity of the resist pattern, which is to serve as a mask in creating the fluorescent screen, can be set independent of each other, stable exposure conditions for the phosphor layers can be achieved. In addition, since the resist pattern is formed through an exposure and processing procedure, the accuracy of the pattern edges thereof is higher as compared to a case where it is formed through etching. By creating the fluorescent screen using this resist pattern, it becomes possible to obtain a fluorescent screen of a higher accuracy.

According to a color cathode ray tube related to an embodiment of the present invention, it is possible to provide a high picture quality color cathode ray tube having a black matrix fluorescent screen of a high accuracy, and in which the phosphor layer edges are sharp while the accuracy of the beam transmissive aperture edges of the color selecting mechanism is moderated. In addition, a high definition color cathode ray tube can be provided, and further, it is suitable for use in post focusing color cathode ray tubes.

According to a method of manufacturing a color cathode ray tube related to an embodiment of the present invention, it is possible to manufacture, in a stable manner and with good accuracy, a high picture quality color cathode ray tube having a black matrix fluorescent screen of a high accuracy, and in which the phosphor layer edges are sharp while the accuracy of the beam transmissive aperture edges of the color selecting mechanism is moderated. In addition, it is suitable for the manufacture of high definition color cathode ray tubes, and further, it is suitable for use in the manufacture of post focusing color cathode ray tubes.

According to a method of creating a fluorescent screen related to the present invention, it is possible to create a black matrix color fluorescent screen with high accuracy in such a manner that the phosphor layer edges become sharper. In addition, it is suitable for use in creating high definition color fluorescent screens, and further, it is suitable for use in creating fluorescent screens for post focusing color cathode ray tubes.

When the base material is selectively etched from the side of the first resist pattern before processing the second photoresist material, it becomes possible to form a second resist pattern having better accuracy.

When the base material is selectively etched from the sides of both the first and the second resist patterns, an improvement in efficiency in creating the mask member can be achieved.

Further, because a so-called dry film, in which a photoresist film is formed on the surface of a light transmissive film, is used as a photoresist material, it becomes possible to form a strong resist pattern, thereby making it possible to make the base material thinner.

### BRIEF DESCRIPTION OF THE DRAWINGS

FIG. 1 is a process chart showing the creation of a fluorescent screen using the color selecting mechanism of FIG. 2 as a mask;

FIG. 2 is a configuration diagram showing an example of a color selecting mechanism that also serves as a conventional mask;

FIG. 3 is a configuration diagram showing an embodiment of a color cathode ray tube related to the present invention;

FIG. 4 is an enlarged sectional view of the main portion of FIG. 3;

FIG. 5 is an enlarged sectional view of the main portion of another embodiment of a color cathode ray tube related to the present invention as applied to a post focusing color cathode ray tube;

FIG. 6A through FIG. 6D are a first set of manufacturing process charts showing an embodiment of a method of making a mask member applied to the manufacture of a color cathode ray tube related to the present invention;

FIG. 7E through FIG. 7H are a second set of manufacturing process charts continued from FIG. 6D;

FIG. 8A through FIG. 8C are manufacturing process charts showing another embodiment of a method of making a mask member applied to the manufacture of a color cathode ray tube related to the present invention;

FIG. 9A and FIG. 9B are manufacturing process charts showing an embodiment of a method of creating a fluorescent screen of a color cathode ray tube related to the present invention;

FIG. 10A is a configuration diagram showing an embodiment of a color selecting mechanism for a color cathode ray tube related to the present invention, and FIG. 10B is an enlarged sectional view thereof;

FIG. 11A is a plan view showing another embodiment of the mask member applied to the manufacture of a color cathode ray tube related to the present invention, FIG. 11B is a rear elevational view thereof, and FIG. 11C is an enlarged sectional view thereof; and

FIG. 12A is a plan view showing another embodiment of the mask member applied to the manufacture of a color cathode ray tube related to the present invention and FIG. 12B is a sectional view thereof.

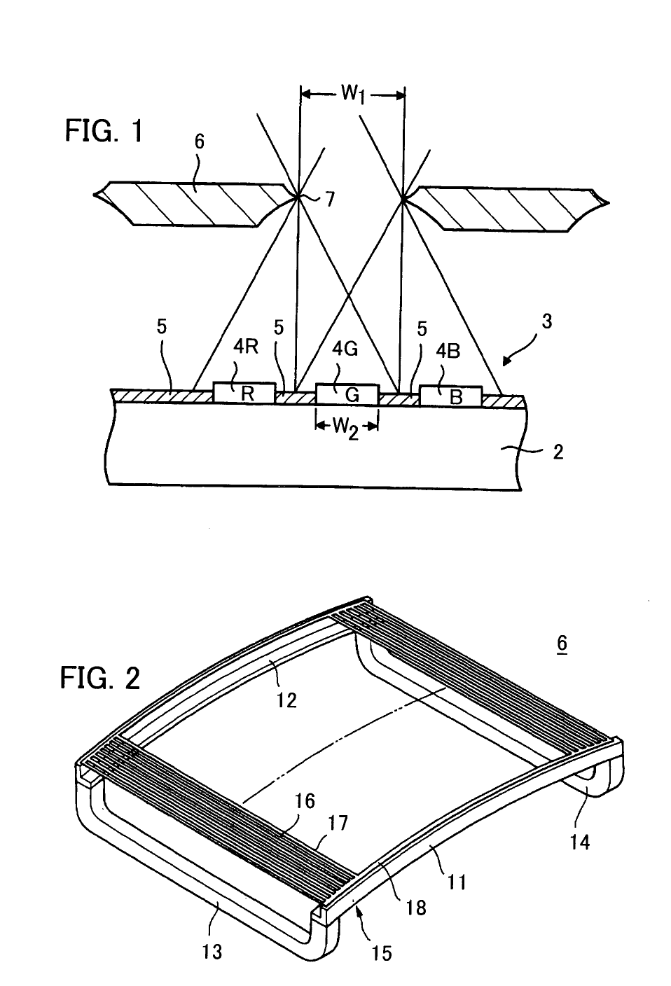

### DETAILED DESCRIPTION OF THE PREFERRED EMBODIMENTS

Embodiments of the present invention will hereinafter be described with reference to the drawings.

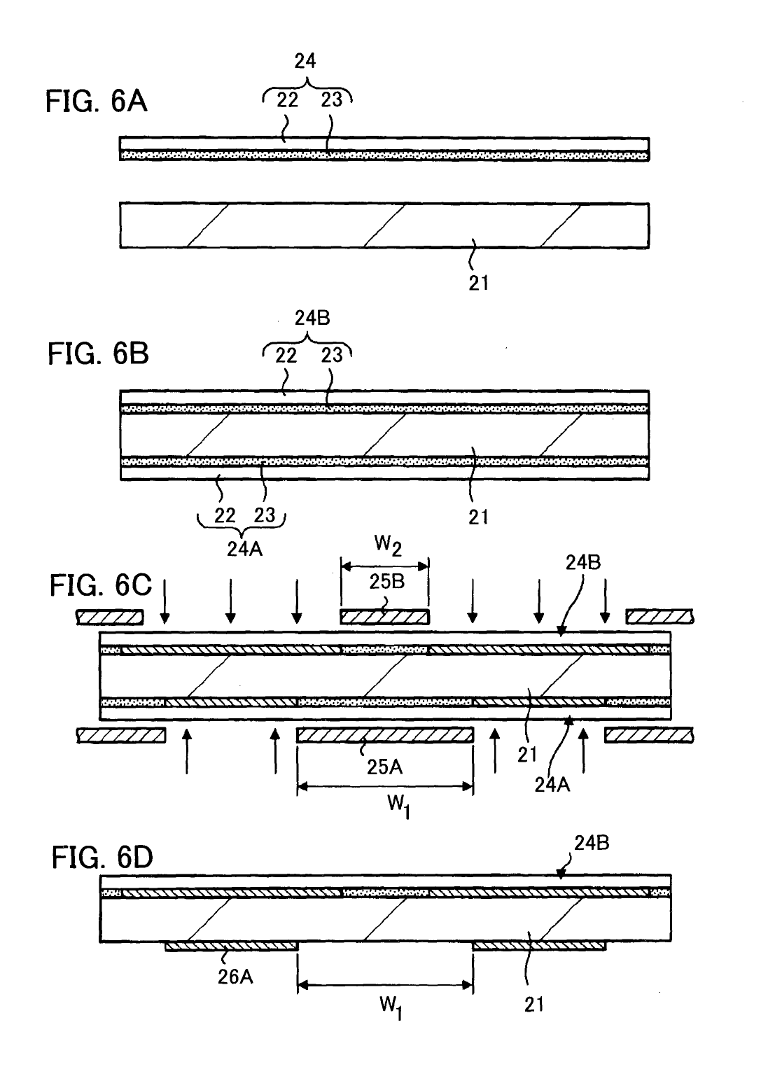

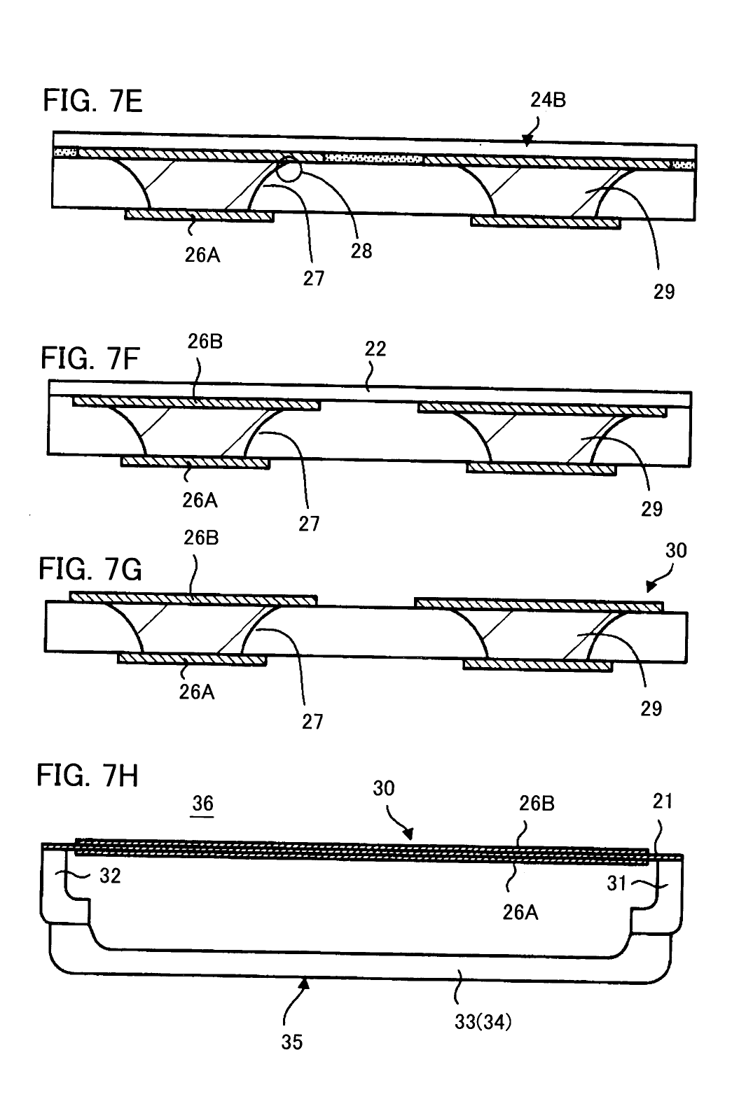

FIGS. 6A through 6D as well as FIGS. 7E through 7H show an embodiment of a method of creating a mask member which serves as a mask when creating a fluorescent screen and which ultimately becomes a color selecting mechanism of a color cathode ray tube related to the present invention. The color selecting mechanism of the present example is one that is referred to as an aperture grill.

First, as shown in FIG. 6A, a base material that ultimately becomes a color selecting electrode thin plate, for example a metal thin plate 21, and a photosensitive resist film, namely a so-called dry film 24, which includes a light transmissive resin film such as a PET (polyethylene terephthalate) film 22, and a photosensitive resist layer 23 formed on one side of the light transmissive resin film 22 are prepared. The photosensitive resist layer 23 of the dry film 24 is very strong. As the photosensitive resist layer 23, for example, Tokyo Ohka Kogyo Co., Ltd.'s F1230 may be used.

Next, as shown in FIG. 6B, a first dry film 24A is adhered on one side of the metal thin plate 21 and a second dry film 24B is adhered on the other side of the metal thin plate 21. The dry films 24 are adhered in such a manner that their photosensitive resist layers 23 face the metal thin plate 21. In the present example, a negative photosensitive resist layer 23 is used. In the present example, the thickness of the metal thin plate 21 is approximately 50 to 100 μm, and the thickness of the dry films 24 is approximately 30 μm.

Next, as shown in FIG. 6C, the first dry film 24A is exposed via a first mask 25A having a pattern corresponding to a slit pattern that ultimately becomes beam transmissive apertures of the color selecting electrode thin plate. In other words, width W₁ of the light blocking sections of the first mask 25A plays a role in determining the width of the beam transmissive apertures. In addition, the second dry film 24B is exposed via a second mask 25B having a pattern corresponding to a stripe pattern that is ultimately to become a mask for creating the fluorescent screen. In other words, width W₂ of the light blocking sections of the second mask 25B plays a role in determining the width of the phosphor stripes. Width W₂ is set so as to be narrower than width W₁. In these exposure processes, light is transmitted through the PET 22, and only the photosensitive resist layer 23 is exposed.

Next, as shown in FIG. 6D, after the PET film 22 of the first dry film 24A is peeled off, processing is performed and the unexposed portions are removed to form a first resist pattern 26A having a first opening width (a so-called slit width) of W₁.

Next, as shown in FIG. 7E, the metal thin plate 21 is selectively etched until the dry film 24B is reached by an etching solution of, for example, iron chloride with the first resist pattern 26A as a mask. In other words, the etching of the metal thin plate 21 is done until the metal thin plate 21 is penetrated and the second dry film 24B is exposed. However, regardless of whether there is polymerization or not, because the photosensitive resist 23 has strong acid-resistance, etching is continued until an area of the second dry film 24B that is larger than the exposed portion is exposed (in other words, until an appropriate small-width slit that is to be formed later is obtained). Through this etching process, a pattern having a plurality of slit-formed beam transmissive apertures 27 of a predetermined slit width and grid element assemblies 29 is formed on the metal thin plate 21. In this etching process, because etching is performed so as to reach the second dry film 24B from one side, the edge sections 28 of the beam transmissive apertures on the side of the second dry film 24B is formed with a sharp edge. In addition, because the etching process is performed from the side of the first dry film 24A in a state where the second dry film 24B is not processed, the edge accuracy of a second resist pattern to be formed later is maintained.

Next, as shown in FIG. 7F, unexposed portions of the second dry film 24B is developed and removed from the side of the first resist pattern 26A, and a second resist pattern 26B is formed. Subsequently, as shown in FIG. 7G, the PET film 22 of the second dry film 24B is peeled off. Thus, a mask thin plate 30 for making the fluorescent screen is obtained. In this mask thin plate 30, both edges of the slit-shaped beam transmissive apertures 27 in the longitudinal direction have their resist layers removed. This mask thin plate 30 is configured as the color selecting electrode thin plate by having the resist panels 26A and 26B removed after the fluorescent screen is made.

Next, as shown in FIG. 7H, a metal frame 35 including a pair of opposing support members 31 and 32, and elasticity creating member 33 and 34 extending between both ends of these support member 31 and 32 is provided. The mask thin plate 30 mentioned above is placed between the opposing support members 31 and 32 of the frame 35 and is fixed in place through welding or the like, and thus, a mask member 36 for creating the fluorescent screen is made.

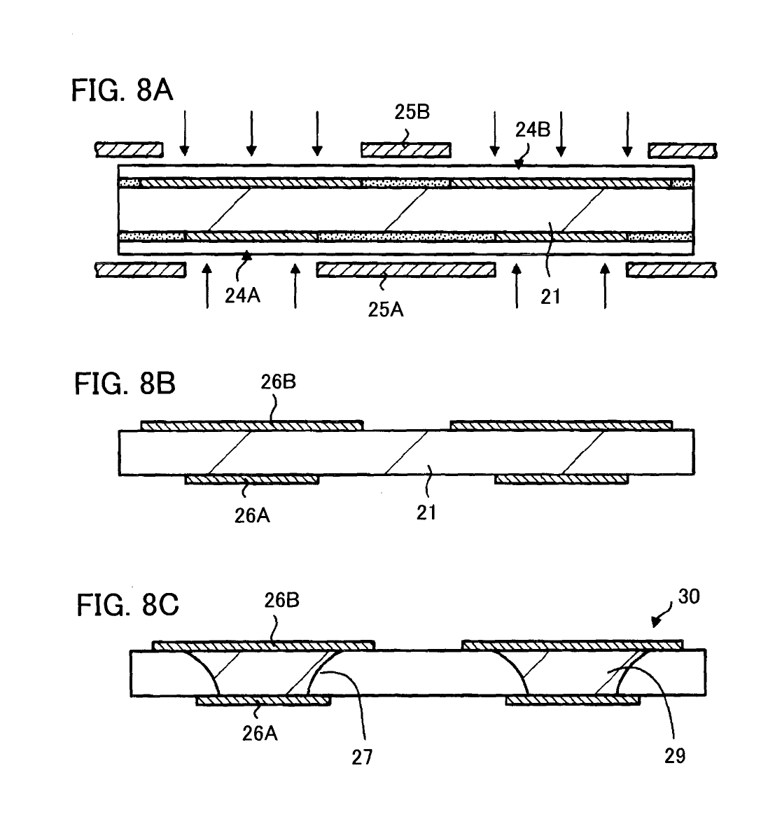

FIGS. 8A through 8C show another embodiment of the method for creating a mask member related to the present invention.

In the present embodiment, as in the process shown in FIG. 6A, the first dry film 24A is exposed via the first mask 25A, and the second dry film 24B is exposed via the second mask 25B as shown in FIG. 8A.

Next, as shown in FIG. 8B, after the PET films 22 of the first and second dry films 24A and 24B are peeled off, a processing procedure is performed and unpolymerized portions are removed, thereby forming the first resist pattern 26A and the second resist pattern 26B.

Next, as shown in FIG. 8C, the metal thin plate 21 is selectively etched from both sides with the first resist pattern 26A and the second resist pattern 26B as masks, and a pattern of slit-shaped beam transmissive apertures 27 that is substantially defined by the first resist pattern 26A is formed. In this etching process, too, the edge sections of the slit-formed beam transmissive apertures 27 on the side of the second resist pattern 26B are formed with sharp edges. The mask thin plate 30 is thus obtained. In this method of making the mask thin plate 30, because etching is performed from both sides of the metal thin plate 21, the efficiency with which the mask thin plate 30 is made is improved.

The mask thin plate 30 thus made is, as described above, placed within the frame 35, is fixed in place, and the mask member 36 for making the fluorescent screen is thus obtained.

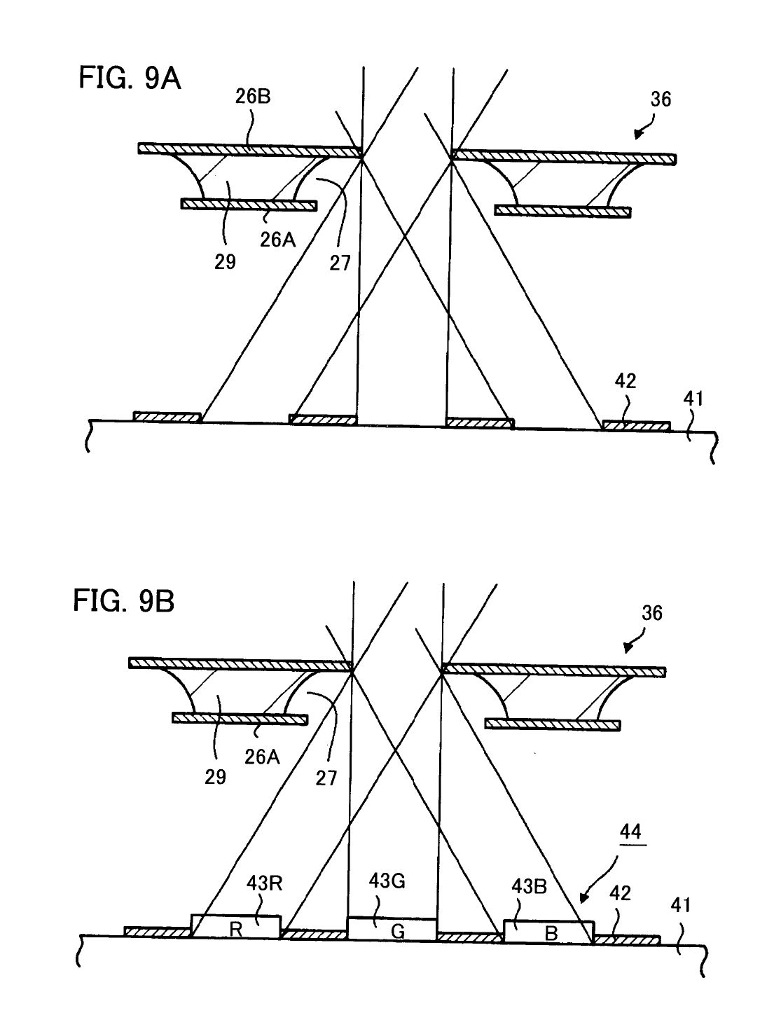

In an embodiment of the present invention, the fluorescent screen of a color cathode ray tube is made using the mask member 36 described above. FIGS. 9A and 9B show an embodiment of a method of making a color fluorescent screen according to an embodiment of the present invention.

As shown in FIG. 9A, using the second resist pattern 26B of the mask member 36 as a mask, a pattern of carbon stripes 42, which is to become a light absorbing layer, is formed on the inner surface of a panel 41 of the housing of the cathode ray tube. In this carbon stripe pattern, although not shown in the drawing, a photosensitive resist film (for example, a PVA photosensitive film) is formed on the inner surface of the panel 41, and with the second resist pattern 26B of the mask member 36 as a mask, by moving the light source relatively to the red, green and blue positions and performing exposure and processing at each position, a resist pattern is formed such that resists remain at the red, green and blue positions. Next, a carbon film is applied on the entire surface, the resist pattern and the carbon film thereon are removed through reversal processing, and a carbon stripe pattern is formed with the remaining carbon film.

Next, a phosphor slurry of the first color, for example green, is applied, and after drying, a green phosphor stripe 43G is formed through exposure and processing with the second resist pattern 26B of the mask member mentioned above as a mask. Similarly, a phosphor stripe 43R of a second color, for example red, and a phosphor stripe 43B of a third color, for example blue, are formed, thereby creating the desired black matrix color fluorescent screen 44 shown in FIG. 9B.

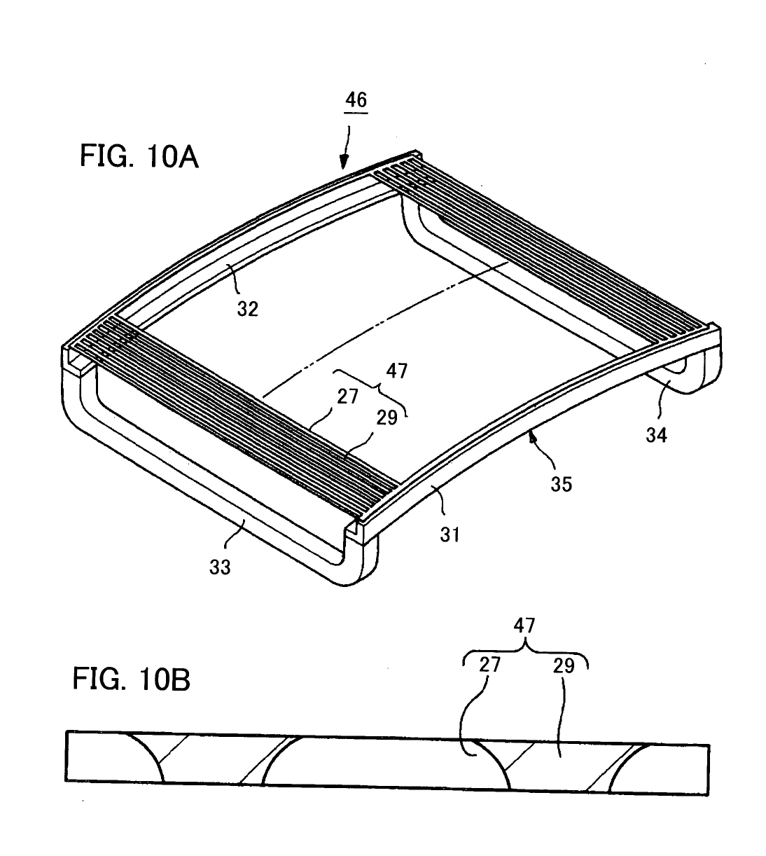

After the color fluorescent screen 44 is created, the first and second resist patterns 26A and 26B on both sides of the mask member 36 are dissolved and removed, and a color selecting mechanism 46 having a color selecting electrode thin plate 47 including a metal thin plate on which are formed a plurality of the grid element assemblies 29 and the beam transmissive apertures 27 therebetween as shown in FIG. 10A. In this color selecting mechanism 46, the slit width of the slit-shaped beam transmissive apertures 27 is wider than the stripe width of the phosphor stripes 43R, 43G and 43B. In an embodiment of the present invention, a color cathode ray tube may be configured by installing this color selecting mechanism 46 on the inner side of the panel.

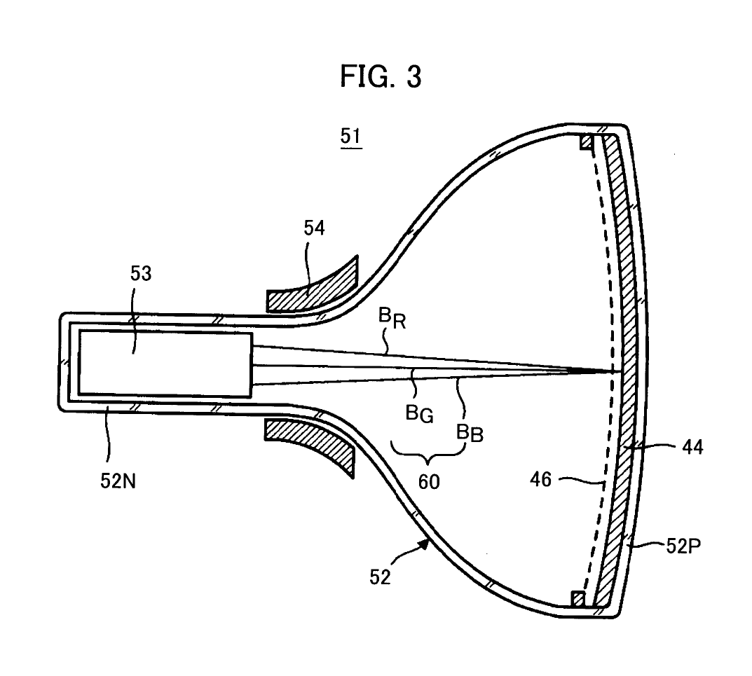

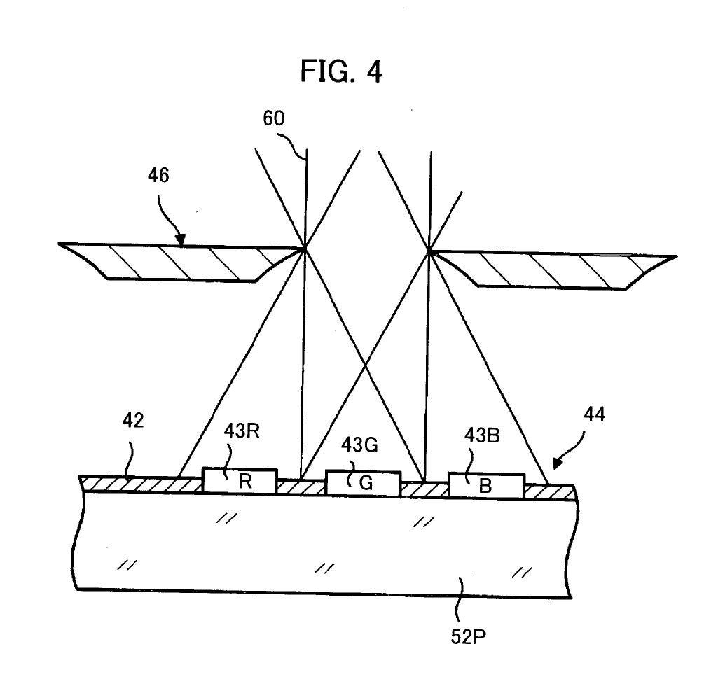

FIG. 3 and FIG. 4 show an embodiment of a color cathode ray tube related to the present invention. In a color cathode ray tube 51 related to the present embodiment, the black matrix fluorescent screen 44 is formed on the inner surface of a panel 52P of a cathode ray tube housing (glass tube housing) 52 using the mask member described above, the color selecting mechanism 46 formed by removing the resist patterns 26A and 26B of the mask member 36 is positioned opposite this fluorescent screen 44, and an electron gun 53 is positioned inside a neck section 52N. On the outside of the tube housing 52, there is provided a deflection yoke for deflecting electron beams 60 [B_{R}, B_{G}, B_{B}] of the respective colors from the electron gun 53 in the horizontal and vertical directions.

According to the embodiment described above, by performing exposure to create the fluorescent screen with the second resist pattern 26B of the mask member 36 as a mask, and configuring the color selecting mechanism by removing the first and second resist patterns 26A and 26B after creating the fluorescent screen, the transmissivity of the mask during exposure can be set at optimal conditions independent of the beam transmissivity of the color selecting mechanism 46. Therefore, the width of exposure of the phosphor stripes can be determined with the slit width of the second resist pattern, and stable exposure conditions of the phosphor stripes can be obtained. Hence, it is possible to form the phosphor stripes 43R, 43G and 43B of a desired width that is narrower than the width of the beam transmissive apertures 27 of the color selecting mechanism 46. In other words, the width of the beam transmissive apertures of the color selecting mechanism is designed so as to optimize the beam width, while the width of the phosphor stripes can be made narrower taking their allowances into consideration. In addition, it becomes possible to control the width of the phosphor stripes extensively with respect to the width of the beam transmissive apertures of the color selecting mechanism 46.

Since the slit edges of the beam transmissive apertures 27 of the color selecting mechanism 46 become unnecessary during the exposure for creating the fluorescent screen, the accuracy requirement can be moderated largely.

Since the mask thin plate 30 can be handled with the PET films 22 present, the PET films 22 function as protective films to thereby ensure sufficient strength, prevent damage during handling, and thus make handling easier. In addition, because additional strength can be obtained, the metal thin plate can be made thinner, and even if the device is made larger and the pitch is made finer, variances in pitch will not occur. As a result, it becomes possible to form a color selecting mechanism of a thin steel plate that is made larger and more fine pitched.

Sine the second resist pattern 26B that serves as a mask is formed through exposure and processing, its pattern edges (namely, the slit edges) are formed sharper as compared to a case where the resist pattern 26B is formed through etching, and it is thus possible to form the phosphor stripes 43R, 43G and 43B with a higher degree of accuracy.

A cathode ray tube having such a color fluorescent screen including phosphor stripes with sharper stripe edges makes it possible to make the definition of images higher.

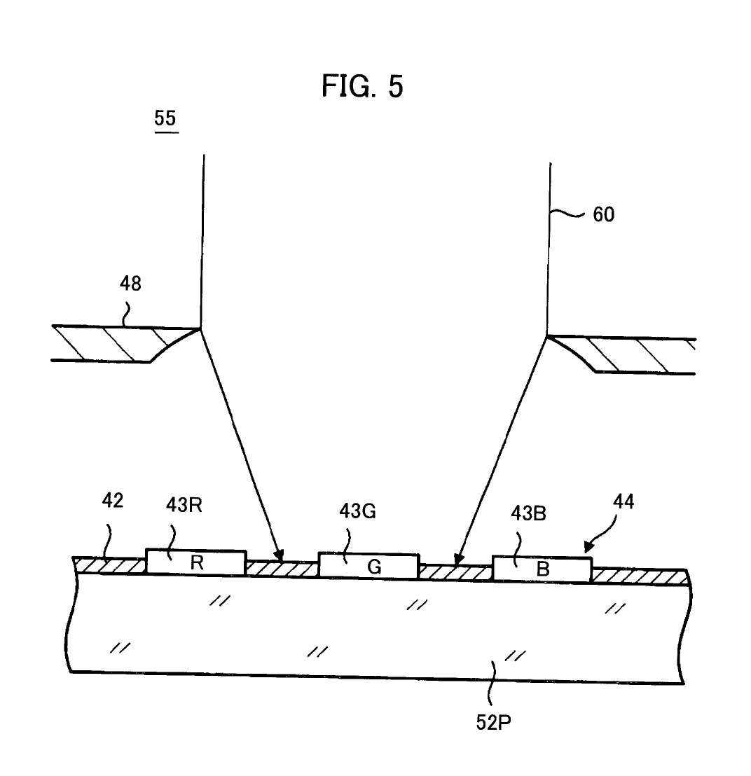

In addition to being applicable to ordinary black matrix color cathode ray tubes, the present embodiment, as shown in FIG. 5, is suitable for application especially in a post focusing color cathode ray tube 55 in which the beam transmissivity of a color selecting mechanism 48 is raised to about 50%, a method of manufacture thereof and a method of making a fluorescent screen and the like.

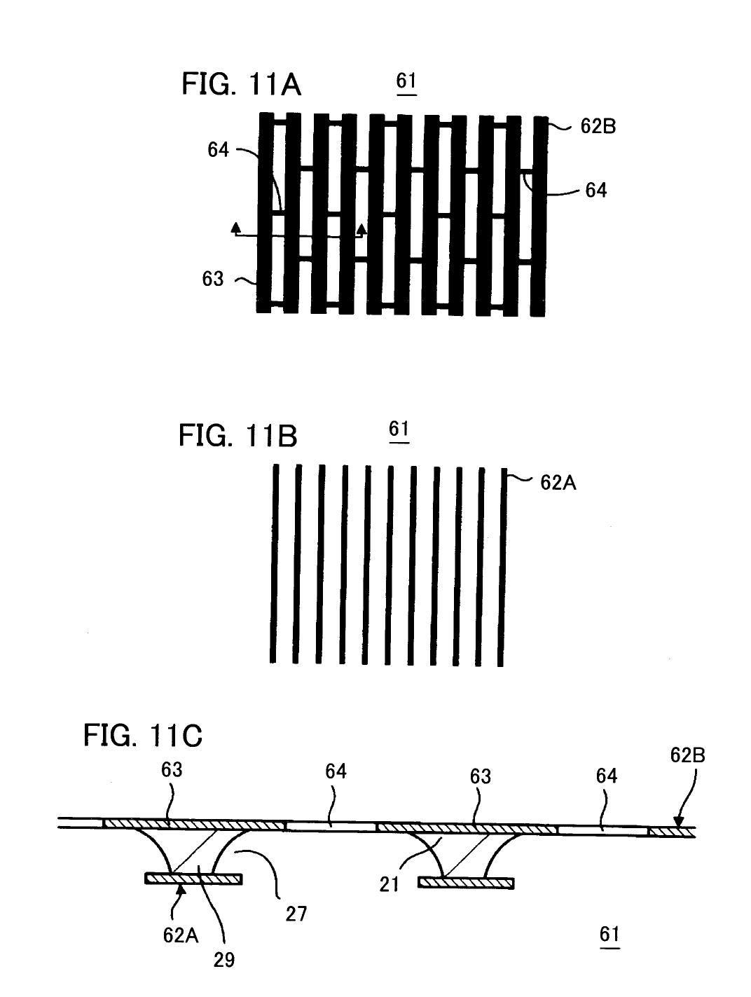

FIGS. 11A through 11C show another embodiment of the mask member. In a mask member 61 related to the present embodiment, a first resist pattern 62A having, as in the embodiment described above, slit-shaped apertures is formed on one side of the metal thin plate 21, and a second resist pattern 62B having a slit width narrower than the slit width of the first resist pattern 62A and in which neighboring stripes 63 with a slit interposed therebetween are partially linked with link sections (so-called bridge sections) 64 is formed on the other side. The link sections 64 are formed with a width narrower than the width of the stripes 63. The etching of the metal thin plate 21 is, as in the case illustrated in FIG. 7E, performed from the side of the first resist pattern 62A, and slits 27 which become beam transmissive apertures are formed.

According to the mask member 61 of the present embodiment, because the second resist pattern 62B is formed in a slot-shaped pattern having the link sections 64, even after the etching of the metal thin plate 21, the grid element assemblies 29 do not fall apart, the pitch of the second resist pattern is stabilized, good uniformity of the slit width is obtained and handling is made easier. When exposure for creating the fluorescent screen is performed using this mask member 61, by using a linear light source, the link sections 64 are not transcribed, and it is made possible to create a fluorescent screen having a striped structure. After the fluorescent screen is created, the first and second resist patterns 62A and 62B are removed, and the color selecting mechanism is formed.

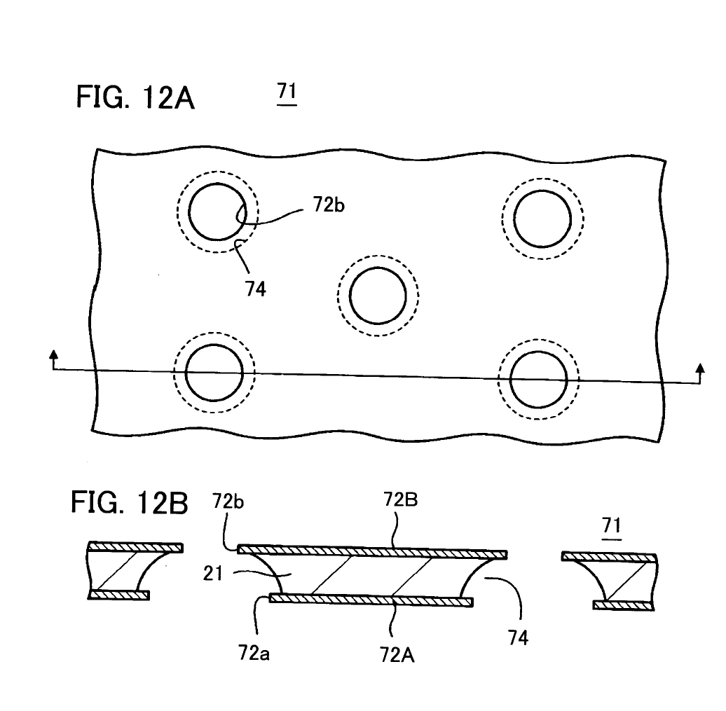

FIGS. 12A and 12B show another embodiment of the mask member. The present embodiment is applied to the creation of a black matrix color fluorescent screen including phosphor dots. In a mask member 71 related to the present embodiment, a first resist pattern 72A having dot-shaped apertures 72a, which contribute to the determination of the diameter of dot-shaped beam transmissive apertures of the color selecting mechanism, is formed on one side of the metal thin plate 21, and a second resist pattern 72B having dot-shaped apertures 72b, which contributes to the determination of the diameter of phosphor dots to be formed, is formed on the other side. The etching of the metal thin plate 21 may be performed from the side of the first resist pattern 72A or from both the side of the first resist pattern 72A and the side of the second resist pattern 72B, thereby forming dot-shaped apertures 74 that become the beam transmissive apertures.

By using this mask member 71, a black matrix color fluorescent screen of a dotted structure can be created. By removing the first and second resist patterns 72A and 72B after creating the fluorescent screen, a color selecting mechanism having dot-shaped beam transmissive apertures is formed.

In addition, in the present invention, it is also possible to create a mask member that is capable of ultimately forming a slotted color selecting mechanism, although not shown in drawing. It is also possible to create a striped color fluorescent screen using this slotted mask member, form the slotted color selecting mechanism by then removing the first and second resist patterns, and configure a color cathode ray tube by installing this slotted color selecting mechanism on the panel.

Since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalents of the claims are intended to be embraced therein.

What is claimed is:

1. A color cathode ray tube, comprising:
a color fluorescent screen created by forming, on a color selecting mechanism, a resist pattern that is independent of beam transmissive apertures of said color selecting mechanism and by using said resist pattern as a mask; and
said color selecting mechanism from which said resist pattern is removed.

2. A method of manufacturing a color cathode ray tube, comprising:
forming on a color selecting mechanism a resist pattern that is independent of beam transmissive apertures of said color selecting mechanism;
creating a fluorescent screen using said resist pattern as a mask; and
forming said color selecting mechanism by removing said resist pattern after creating said fluorescent screen.

3. A method of manufacturing a color cathode ray tube, comprising:
forming a mask member that is obtained by forming a first resist pattern having one of a first aperture width and a first aperture diameter on one side of a base material, forming a second resist pattern having one of a second aperture width and a second aperture diameter that is smaller than one of said first aperture width and said first aperture diameter on the other side of said base material, and selectively removing said base material with said first resist pattern, substantially, as a mask;
creating a fluorescent screen using said second resist pattern of said mask member as a mask; and
forming a color selecting mechanism by removing said first resist pattern and said second resist pattern of said mask member after creating said fluorescent screen.

4. A method of manufacturing a color cathode ray tube, comprising;
forming a mask member by,
forming a first photoresist material on one side of a base material and a second photoresist material on the other side;
exposing said first photoresist material and said second photoresist material in differing patterns;
forming a first resist pattern having one of a first aperture width and a first aperture diameter by processing said first photoresist material;
selectively removing said base material with said first resist pattern as a mask until said second photoresist material is reached; and
forming a second resist pattern having one of a second aperture width and a second aperture diameter that is smaller than one of said first aperture width and said first aperture diameter by processing said second photoresist material, and
forming a color selecting mechanism by,
creating a fluorescent screen using said second resist pattern of said mask member as a mask; and
removing said first resist pattern and said second resist pattern of said mask member after creating said fluorescent screen.

5. A method of manufacturing a color cathode ray tube, comprising:
forming a mask member by,
forming a first photoresist material on one side of a base material and a second photoresist material on the other side;
exposing said first photoresist material and said second photoresist material in differing patterns;
forming a first resist pattern having one of a first aperture width and a first aperture diameter by processing said first photoresist material;
forming a second resist pattern having one of a second aperture width and a second aperture diameter that is smaller than one of said first aperture width and said first aperture diameter by processing said second photoresist material; and
selectively removing said base material in a pattern corresponding to said first resist pattern with said first resist pattern and said second resist pattern as masks, and
forming a color selecting mechanism, by
creating a fluorescent screen using said second resist pattern of said mask member as a mask; and
removing said first resist pattern and said second resist pattern of said mask member after creating said fluorescent screen.

6. A method of creating a fluorescent screen, comprising:
forming on a color selecting mechanism a resist pattern that is independent of a beam transmissive aperture pattern of said color selecting mechanism;
performing an exposure process for creating said fluorescent screen using said resist pattern as a mask.

7. A method of creating a fluorescent screen, comprising:
forming a mask member that is obtained by forming a first resist pattern having one of a first aperture width and a first aperture diameter on one side of a base material, forming a second resist pattern having one of a second aperture width and a second aperture diameter that is smaller than one of said first aperture width and said first aperture diameter on the other side of said base material, and selectively removing said base material with said first resist pattern, substantially, as a mask; and
performing an exposure process for creating said fluorescent screen using said second resist pattern of said mask member as a mask.

8. A method of creating a fluorescent screen, comprising:
forming a mask member by,
forming a first photoresist material on one side of a base material and a second photoresist material on the other side;
exposing said first photoresist material and said second photoresist material in differing patterns;
forming a first resist pattern having one of a first aperture width and a first aperture diameter by processing said first photoresist material;
selectively removing said base material with said first resist pattern as a mask until said second photoresist material is reached; and
forming a second resist pattern having one of a second aperture width and a second aperture diameter that is smaller than one of said first aperture width and said first aperture diameter by processing said second photoresist material, and
performing an exposure process for creating said fluorescent screen using said second resist pattern of said mask member as a mask.

9. A method of creating a fluorescent screen, comprising:
forming a mask member by,
forming a first photoresist material on one side of a base material and a second photoresist material on the other side;
exposing said first photoresist material and said second photoresist material in differing patterns;
forming a first resist pattern having one of a first aperture width and a first aperture diameter by processing said first photoresist material;
forming a second resist pattern having one of a second aperture width and a second aperture diameter that is smaller than one of said first aperture width and said first aperture diameter by processing said second photoresist material; and
selectively removing said base material in a pattern corresponding to said first resist pattern with said first resist pattern and said second resist pattern as masks, and
performing an exposure process for creating said fluorescent screen using said second resist pattern of said mask member as a mask.

10. The method of creating a fluorescent screen according to claim 7, wherein said first photoresist material and said second photoresist material include a photoresist film formed on a surface of a light transmissive resin film.

11. The method of creating a fluorescent screen according to claim 8, wherein said first photoresist material and said second photoresist material include a photoresist film formed on a surface of a light transmissive resin film.

12. The method of creating a fluorescent screen according to claim 9, wherein said first photoresist material and said second photoresist material include a photoresist film formed on a surface of a light transmissive resin film.

13. The method of creating a fluorescent screen according to claim 7, wherein said first resist pattern and said second pattern are both striped patterns.

14. The method of creating a fluorescent screen according to claim 8, wherein said first resist pattern and said second pattern are both striped patterns.

15. The method of creating a fluorescent screen according to claim 9, wherein said first resist pattern and said second pattern are both striped patterns.

16. The method of creating a fluorescent screen according to claim 7, wherein said first resist pattern is a striped pattern, and said second resist pattern is a pattern in which neighboring stripes are partially linked.

17. The method of creating a fluorescent screen according to 8, wherein said first resist pattern is a striped pattern, and said second resist pattern is a pattern in which neighboring stripes are partially linked.

18. The method of creating a fluorescent screen according to claim 9, wherein said first resist pattern is a striped pattern, and said second resist pattern is a pattern in which neighboring stripes are partially linked.

19. The method of creating a fluorescent screen according to claim 7, wherein said first resist pattern and said second resist pattern are both dotted patterns.

20. The method of creating a fluorescent screen according to claim 8, wherein said first resist pattern and said second resist pattern are both dotted patterns.

21. The method of creating a fluorescent screen according to claim 9, wherein said first resist pattern and said second resist pattern are both dotted patterns.
